(19) United States
(12) Patent Application Publication
(10) Pub. No.: US 2016/0214522 A1
(43) Pub. Date: Jul. 28, 2016

(54) FOLDING LINER

(71) Applicant: Joseph T. Marshall, Pine Grove, CA (US)

(72) Inventor: Joseph T. Marshall, Pine Grove, CA (US)

(21) Appl. No.: 14/671,886

(22) Filed: Mar. 27, 2015

Related U.S. Application Data
(60) Provisional application No. 62/108,550, filed on Jan. 28, 2015.

(51) Int. Cl. B60P 1/64; B60R 13/01; B62D 33/02; B60P 7/08; B60R 5/04

(52) U.S. Cl. CPC B60P 1/6409; B60P 7/0892; B60R 5/044; B60P 7/0884; B62D 33/0207; B60R 13/01; B60R 2013/015; B60R 2013/016; B60R 2013/018

(57) ABSTRACT

A folding liner includes multiple sections connected with hinges. The folding liner slides within a cargo area such as a truck bed to facilitate loading and unloading of cargo without the need to climb into the cargo area or lift cargo over side walls. The folding liner when folded can partition a cargo area into one or more smaller cargo areas or can cover a cargo to hide the cargo or prevent the cargo from flying out of an open cargo area of a moving vehicle.

### CROSS-REFERENCE TO RELATED APPLICATIONS

This patent document claims benefit of the earlier filing date of U.S. Provisional Pat. App. No. 62/108,550, filed Jan. 28, 2015, which is hereby incorporated by reference in its entirety.

### BACKGROUND

Vehicles such as trucks, vans, SUVs, and trailers often include cargo areas that are longer than a user's reach. Loading or unloading of these cargo areas may thus required that a person climb into cargo area in order to reach the portion of the cargo area furthest from a tailgate or other access to the cargo area. For example, light-duty trucks or pickups typically have beds that are five to eight feet long and placing or reaching cargo in the bed closest to a truck's cab may require a person to climb into the truck bed or reach over the side of the truck bed. Truck accessories such as camper shells, hard or soft tonneau covers, and other types of devices covering the bed may block side access to the bed and restrict the available height over a cargo area, so that loading or unloading may require a person to crawl into or through the bed under the cover.

Trucks have employed cargo systems such as lift gates, dump beds, drawers, and tool boxes. Many of these systems are cumbersome, expensive, and require modifications to the vehicle at least to bolt portions of the system to the vehicle, making such systems impractical or undesirable for many users.

### SUMMARY

In accordance with an aspect of the invention, a folding bed liner includes multiple rigid sections interconnected with hinges that permit relative folding of the sections. The folding bed liner may be used in a truck bed or other cargo area without mechanical attachments to a vehicle. Thus, a user can slide and fold the liner during loading and unloading of cargo. In particular, a loading process may begin by placing a section of the liner in the cargo area at a convenient location for loading while other sections are folded out of the way. Cargo can be loaded onto the section in the loading position, and then the liner with the loaded cargo can be slid further into the cargo area in order to position a next section of the folding bed liner for convenient loading. Loading can continue section by section until the last section of the folding bed liner is slid into the cargo area. Unloading reverses the loading process by sliding a section out to the loading/unloading position, unloading cargo from the section in that position, and sliding the folding bed liner further out while folding the unloaded section or sections out of the way and positioning the next section for unloading.

The folding bed liner can also fold to create at least one wall that partitions a cargo area into smaller areas that can hold smaller loads and prevent the smaller loads from shifting, sliding, or rolling across the cargo area. In particular, a partition wall created by a tent-shaped folding of the middle and tail sections of a folding liner can create a small cargo area of adjustable size, near the tailgate of a truck and prevent cargo from sliding toward the cab of the truck.

The folding bed liner can also fold to cover cargo, for example, to hide the cargo from easy viewing or prevent cargo from flying out of an open cargo area.

The folding liner can be inexpensively manufactured using rigid sheets that form the sections and hinges that permit the desired folding actions, and folding of the liner into a compact configuration permits inexpensive shipping of the liner and storage of the liner in a relatively small space when the liner is not in use.

One specific implementation disclosed herein is a folding bed liner including a first section, a second section, and a third section. A first hinge system connects the first section and the second section so that the second section may be tilted relative to the first section, and a second hinge system connects the second section and the third section so that the third section may be tilted relative to the second section.

Another specific implementation disclosed herein is a loading or unloading process. The process includes: placing a folding liner in a first configuration in which a first section of the folding liner in a loading position for a cargo area of a vehicle and second and third sections of the folding liner are folded; sliding the first section of the folding liner along a floor of the cargo area so that the folding liner moves between the first configuration and a second configuration in which the first section is in the cargo area, the second section is in the loading position, and the third section is folded; and sliding the first section and the second section of the folding liner along the floor of the cargo area so that the folding liner moves between the second configuration and a third configuration in which the first section and the second section are in the cargo area and the third section is in the loading position.

### BRIEF DESCRIPTION OF THE DRAWINGS

FIGS. 1A and 1B respectively show a plan view and a side view of one implementation of a folding bed liner.

FIGS. 2A, 2B, 2C, 2D, and 2E illustrate a process of loading or unloading a cargo area using a sliding, folding bed liner.

FIGS. 3A and 3B show alternative configurations of a folding bed line being employed to partition a cargo area and keep cargo near a loading/unloading area of a cargo area.

FIG. 4 shows an implementation of a folding bed liner being employed to hide or hold down cargo in a cargo area.

FIG. 5 shows a plan view of another implementation of a folding bed liner.

The drawings illustrate examples for the purpose of explanation and are not of the invention itself. Use of the same reference symbols in different figures indicates similar or identical items.

### DETAILED DESCRIPTION

A sliding, folding liner aids in loading and unloading of truck beds or other cargo areas of vehicles without the need to climb into the cargo area or the need to lift cargo over the side walls of the cargo area. The folding liner can be used as a free floating device that slides for loading and unloading processes and does not need to be mounted to a vehicle. The folding liner may also fold to partition a truck bed or other cargo area into multiple compartments for holding smaller loads and preventing or reducing the shifting, sliding, or rolling the cargo while a vehicle travels. One particular configuration can create a small cargo area with adjustable size to keep cargo near a tailgate of a truck bed and prevent the cargo from sliding or rolling to the cab of truck during travel. The folding liner may also be capable of folding to create a covered cargo space to hide cargo or prevent cargo from flying out of an open cargo area of a moving vehicle. The liner can also be folded into a compact configuration for shipping or storage of the liner.

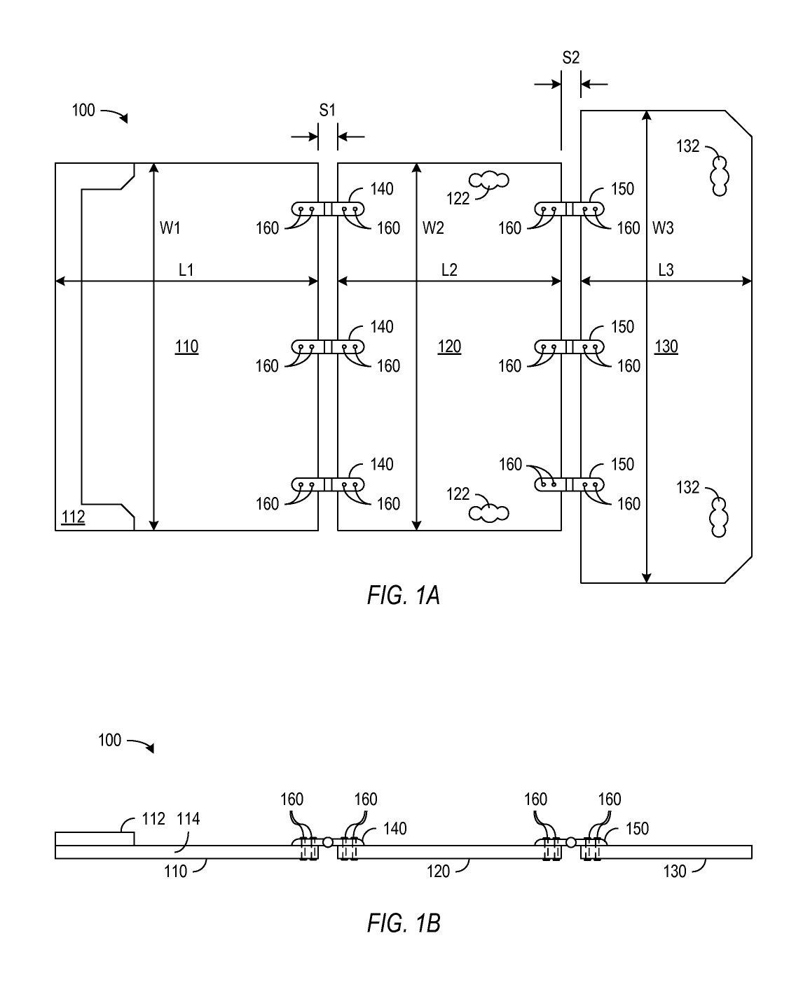

FIGS. 1A and 1B respectively show a plan view and a side view of a folding liner 100 in accordance with one implementation. Folding liner 100 includes three rigid sections 110, 120, and 130. Section 110 is sometimes referred to herein as cab-ward section 110 since section 110 may be placed in a truck bed nearest the cab of the truck, and section 130 is sometimes referred to herein as tail section 130 since section 130 may be placed in a truck bed nearest the tailgate of the truck. Each of sections 110, 120, and 130 may be made of any sufficiently rigid and durable material, and in one specific implementation, sections 110, 120, and 130 are made of Acrylonitrile Butadiene Styrene (ABS) or other plastic sheets. A first set of hinges 140 connect sections 110 and 120 to allow folding or tilting of section 120 relative to section 110, and a second set of similar or identical hinges 150 connect sections 120 and 130 to allow folding or tilting of section 130 relative to section 120.

Sections 110, 120, and 130 may be substantially flat to be placed on and to slide on a floor of a cargo areas such as the floor of a truck bed. It may be noted that a truck bed or other cargo area in which folding liner 100 is used may or may not have a conventional bed liner or other structure between folding liner 100 and the vehicle, and that the floor of cargo area generally refers to the surface on which folding liner 100 slides, whether or not the surface was part of the vehicle when sold new. The bottom surfaces of sections 110, 120, and 130 and folding liner 100 as a whole may provide a smooth, low-friction, easy slide finish to facilitate sliding of folding liner 100 on the floor of a cargo area. In contrast, top surfaces of sections 110, 120, and 130 may be textured, e.g., with a standard bed liner finish, to reduce sliding of cargo that may be placed on folding liner 100. In the implementation of FIGS. 1A and 1B, cab-ward section 110 further has a cab-ward edge with a lip 112 to keep a load from sliding off that edge of liner 100 particularly during loading or unloading processes as described further below. Lip 112 may be relatively shallow, e.g., have a thickness that is about the same as the thickness of a base 114 of section 110, and in the exemplary implementation, lip 112 and base 114 are formed of ¼-inch thick ABS plastic that is glued, fused, or otherwise bound together. More specifically, lip 112 may be glued to a 1.5″ inch wide portion along the cab-ward edge of base 134 and portions of the side edges of base 114 as shown in FIG. 1A.

Tail section 130 has handles 132, which in the exemplary implementation consist of hand holes formed through tail section 130. Handles 132 may be flush cut, easy grip handles drilled through a base sheet of ABS plastic that forms section 130. Other types of handles, e.g., handles that project from the top surface of section 130, could alternatively or additionally be employed. FIG. 1A shows two handles 132 located to help a user grip tail section 130 with both hands. Alternatively, any number of handles may be provided. For example, in addition to or instead of the two handles 132 shown, a centered handle (not shown) may be provided to facilitate one-handed use of folding liner 100. Handles 132 may assist a user in gripping tail section 130, for example, when pushing or pulling section 130 to slide folding liner 100 in or out of a cargo area during a loading or unloading process such as described further below. Similar handles, e.g., handles 122, may be provided on other sections 120 or 110 of liner 100 to assist in gripping the other sections.

The lengths and widths of sections 110, 120, and 130 may be tailored or adjusted according to the dimensions of the vehicle in which liner 100 will be used. For example, if liner 100 is intended for use in a truck bed of a particular make and model of truck, portions of folding liner 100 that need to slide between wheel wells of the truck bed may have widths less than the distance between the wheel wells of that truck, e.g., typically about four feet for full sized pickup trucks and less than four feet for smaller trucks. In the illustrated implementation, cab-ward section 110 and middle section 120 are rectangular and have widths W1 and W2 that may be the same and may fit between wheel wells of the truck bed for which liner 100 is tailored, but tail section 130, which does not need to slide between wheel wells, may have a greater width W3 that fits the width of the truck bed near the tailgate. A sum (L1+L2+L3+S1+S2) of the respective lengths L1, L2, and L3 of sections 110, 120, and 130 and the separations S1 and S2 provided between sections 110, 120, and 130 for hinges 140 and 150 may similarly be less than the interior length of a truck bed, so that folding liner 100 fits within that particular truck bed. Each individual section 110, 120, or 130 may further have a length L1, L2, or L3 that is limited to avoid exceeding a convenient reach for loading, e.g., less than about three feet, and as described further below, the length L2 of middle section 120 may be selected to be less than the height above the ground of the tailgate or other loading portion of a cargo area.

Sections 110, 120, and 130 may be manufactured to have respective widths W1, W2, and W3 and respective lengths L1, L2, and L3 that are fixed and sized for particular vehicles. Alternatively, one or more of sections 110, 120, and 130 may have a length or width that a user may adjust for a particular vehicle or a particular use.

Hinges 140 and 150 may be sufficient in number and strength to withstand the forces needed to slide folding liner 100 when folding liner 100 is loaded with cargo. In an exemplary implementation, hinges 140 and 150 are 4-inch, heavy duty strap hinges, and each set of hinges 140 (or 150) includes three hinges attached to adjacent sections 110 and 120 (or 120 and 130) with steel rivets, e.g., ¼-inch binding rivets. Hinge systems using rivets and strap hinges can withstand the forces need to slide liner 100 while loaded, e.g., with one hundred pounds, two hundred pounds, or more of cargo per section 110, 120, or 130. More generally, a hinge system connecting sections 110 and 120 or connecting sections 120 and 130 can employ any number or type of hinges that collectively provide sufficient strength. As used herein, a hinge system is not limited to a multi-piece structure but may employ one or more flexures, rings, or structures that permits hinge-type relative movement of two sections and allows pushing or pulling of liner 100.

Hinges 140 and 150 as connected to sections 110, 120, and 130 must also provide a desired range of angular motion, e.g., relative tilting of sections 110, 120, and 130. In particular, hinges 150 may provide a minimum range to tilt tail section 130 down at least 90° from section 120, up at least 90° from section 120, or both. Hinges 140 may only be required to tilt section 120 up or down by about 90° from section 110. In one implementation, hinges 140 or 150 provide 270° of motion, limited to tilting down from flat by no more than about 90°. In an exemplary implementation, hinges 140 allow middle section 120 to be tilted upward 180° so that section 120 is parallel to section 110 with top surfaces of sections 110 and 120 adjacent to each other, and hinges 150 allow tail section 130 to be tilted downward 180° so that section 130 is parallel to section 120 with bottom surfaces of sections 120 and 130 adjacent to each other. Folding liner 100 with the exemplary hinges 140 and 150 can thus be folded into a compact configuration in which sections 110, 120, and 130 are parallel and stacked. The compact configuration may allow for inexpensive shipping of liner 100 and storage of liner 100 in relatively small spaces, such as behind the seats in a truck cab.

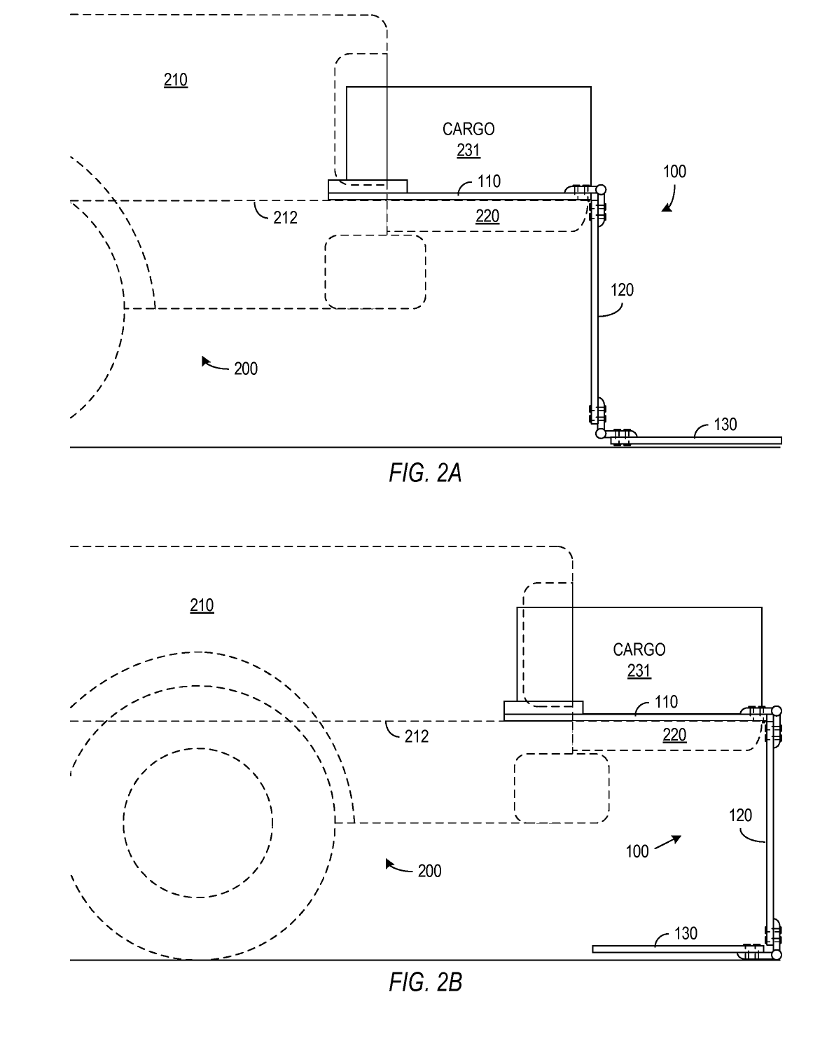

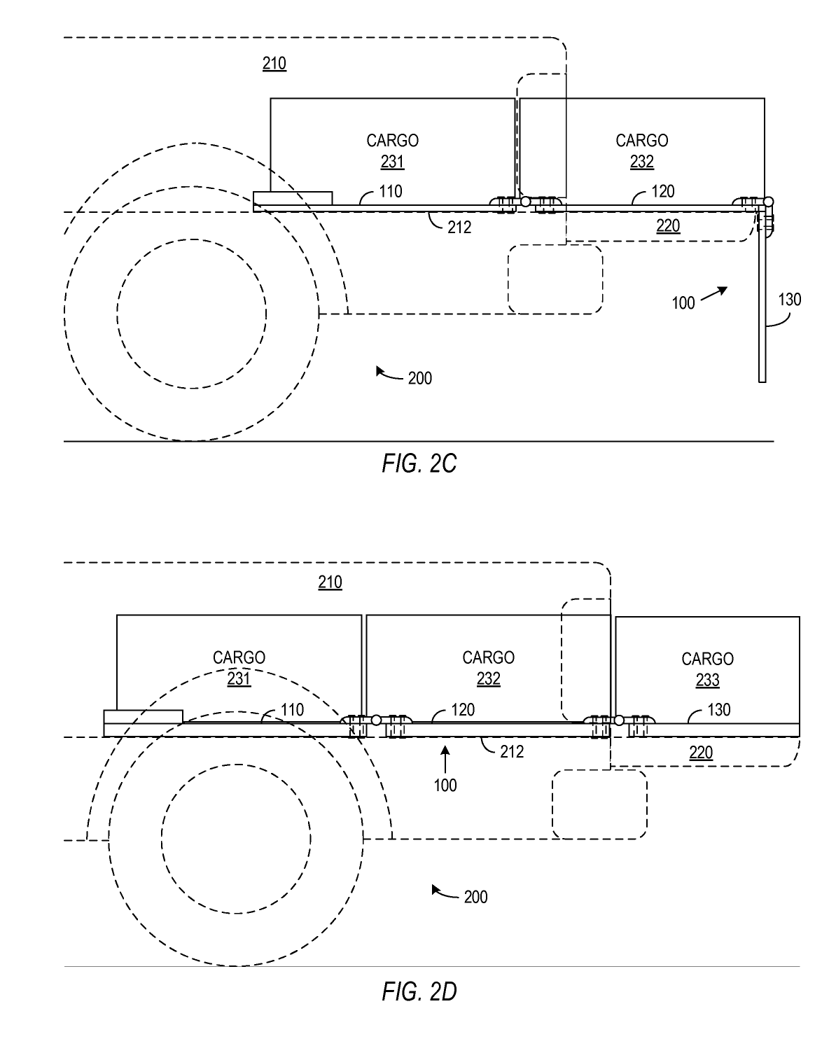

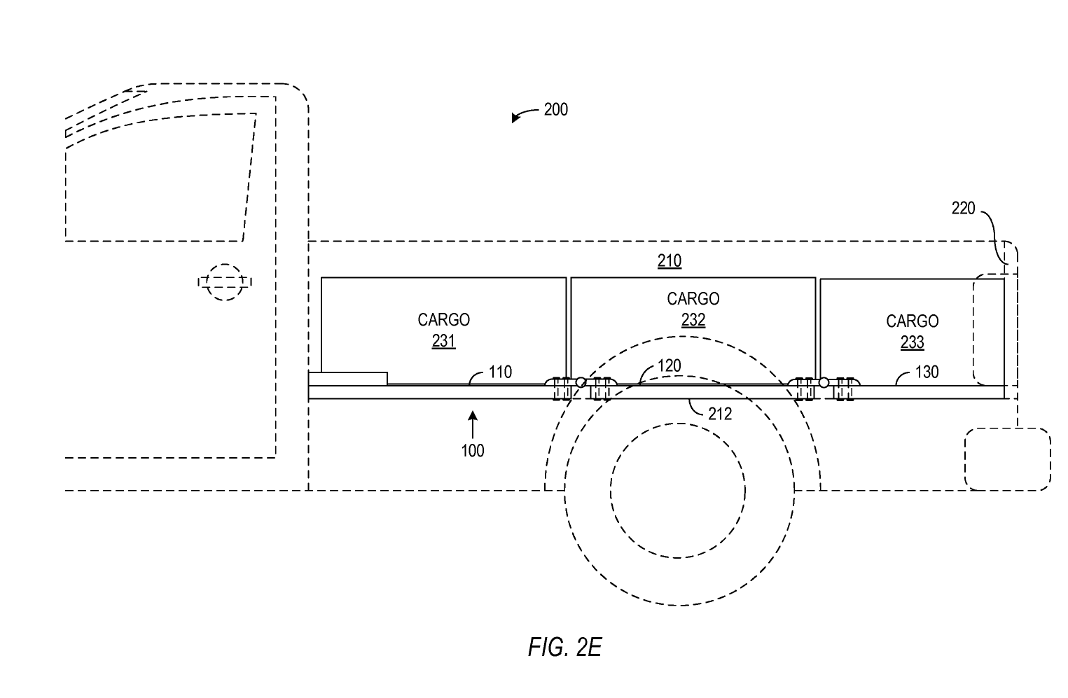

FIGS. 2A to 2E illustrate a process for using a sliding, folding bed liner 100 during a loading (or unloading) process. FIGS. 2A to 2E particularly illustrate the example of loading (or unloading) cargo in a truck bed 210 of a truck 200, but more generally similar loading (or unloading) techniques may be employed for cargo areas of trailers, vans, SUVs, or other vehicles. The type of cargo loaded can be any sufficiently solid objects that fit within the available cargo area.

FIGS. 2A and 2B show alternative configurations for folding liner 100 during loading or unloading of cab-ward section 110. For both configurations, cab-ward section 110 may be placed in a loading position for the cargo area, e.g., at least partly on a tailgate 220 or floor 212 of truck bed 210. Section 120 of liner 100 is folded downward from section 110, and section 130 is folded out of the way. The configurations of FIG. 2A differs from the configuration of FIG. 2B in the direction in which section 130 folds. In FIG. 2A, section 130 is folded up from section 120 and extends away from truck 200. In FIG. 2B, section 130 is folded down from section 120 and extends under tailgate 220. In both configurations, sections 120 and 130 are out of the way, so that cargo 231 can be loaded onto section 110 without the need for a user to bend or reach into truck bed 210. Tailgate 220 or cargo area floor 212 bears the weight of cargo 231 when loaded on section 110.

Once desired cargo 231 is on section 110, section 120 can be lifted and liner 100 can be slid further into truck bed 210 until liner 100 reaches the configuration of FIG. 2C. In the configuration of FIG. 2C, middle section 120 of liner 100 is in the loading position for the cargo area, e.g., on a tailgate 220 or floor 212 of truck bed 210. Tail section 130 of liner 100 is folded downward from section 120, so that section 130 does not impede loading of more cargo 232 onto section 120. Again, a user can load cargo 232 on section 120 without bending and reaching into truck bed 210.

Once desired cargo 232 is on section 120, tail section 130 can be lifted so that liner 100 can be slid further into truck bed 210 until liner 100 reaches the configuration of FIG. 2D. In the configuration of FIG. 2D, tail section 130 is in the loading position for the cargo area, e.g., on a tailgate 220 or floor 212 of truck bed 210, and tail section 120 can be loaded with still more cargo 233. The entire liner 100 while flat and loaded with cargo 231, 232, and 233 can be slid in truck bed 210, e.g., from the configuration of FIG. 2D to the configuration of FIG. 2E, so that the tailgate 220 may be closed and may prevent liner 100 or cargo 231, 232, or 233 from sliding while truck 200 travels. As shown in FIG. 2E, folding liner 100 may be sized to fit snugly within a particular truck bed 210 when liner 100 is flat with an edge of cab-ward section 110 against the cab-ward wall of truck bed 210 and tailgate 220 is closed.

Unloading may proceed by reversing the loading process. Starting with the loaded truck 200 of FIG. 2E, to unload an entire truck bed of cargo 231, 232, and 233, a user can open tailgate 110, grip the handles on tail section 130 to pull folding liner 100 until tail section 130 is on tailgate 220 as shown in FIG. 2D. This puts tail section 130 and cargo 233 directly in front of the user, so that the user has no need to lean in or bend over tailgate 220 to unload cargo 233. This is especially helpful when cargo 233 is heavy or awkward to lift. After unloading cargo 233, the user may now pull folding liner 100 further out of truck bed 210 and then fold tail section 130 down over tailgate 220 and out of the way as shown in FIG. 2C. This facilitates the easy unloading of cargo 232 from middle section 120. After unloading cargo 232, the user pulls folding liner 100 outward again and folds middle section 120 of line 100 down over tailgate 220 with tail section 130 of liner 100 resting on the pavement or other horizontal surface as shown in FIG. 2A or 2B. Cab-ward section 110 and cargo 231 is then sitting ready for unloading, e.g., on tailgate 220 and easily accessible.

Conventionally, unloading (or loading) the cargo closest to the cab of a truck is difficult but is especially problematic when the truck has a camper shell, bed topper, or tonneau cover, but with an unloading (or loading) process using sliding, folding bed liner 100, the user can unload (or load) cargo from a convenient position, e.g., at the tailgate of a truck. The loading and unloading processes that FIGS. 2A to 2E illustrate can thus be easily performed even with a truck having a camper shell, bed topper, or tonneau cover in place.

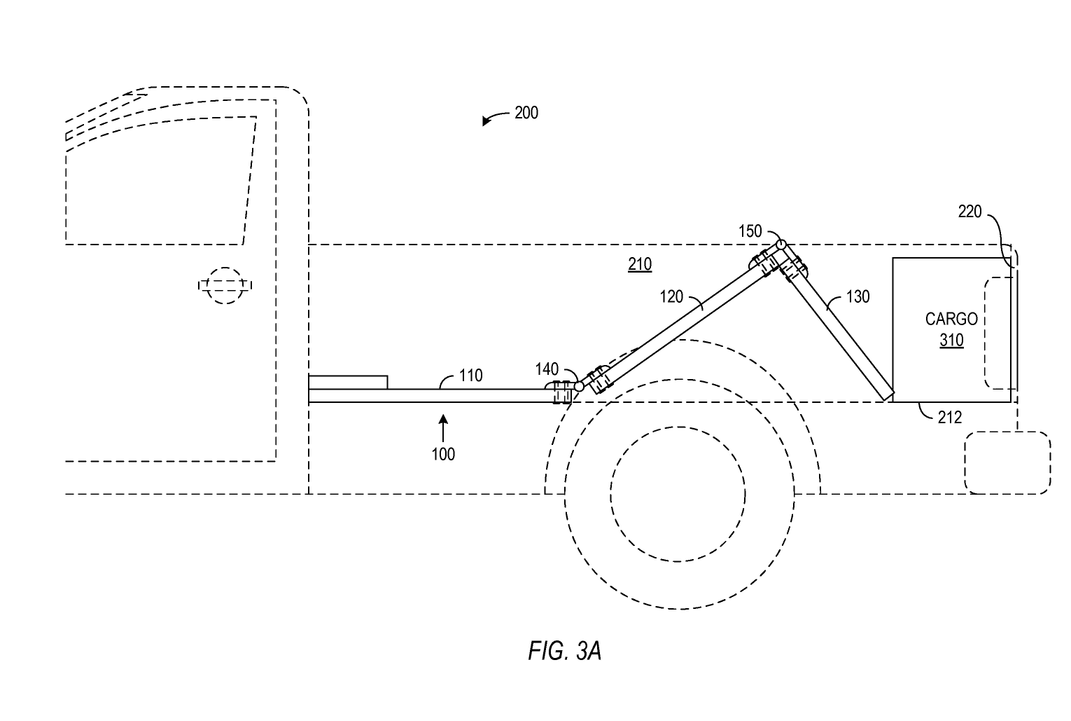

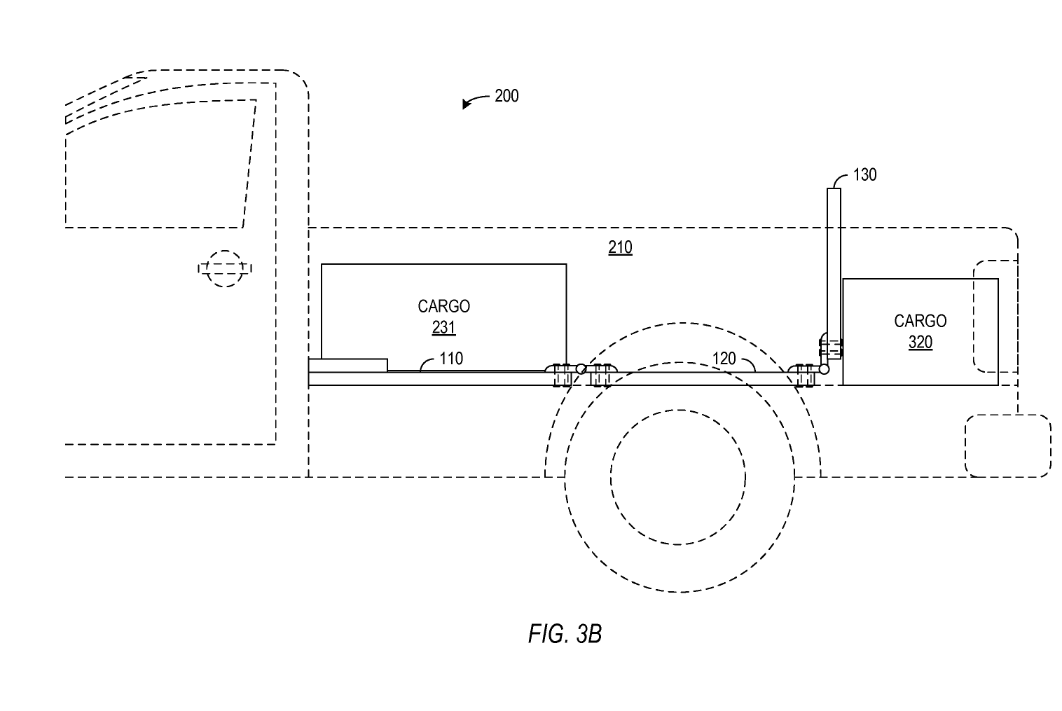

Folding cover 100 can also be configured to secure smaller loads in a large cargo area. One issue for cargo carrying is small cargo that tends to tip over, slide, or roll around in a large cargo area. For example, during travel, small loads in a truck bed tend to tip over and slide to the front of the truck bed when a driver applies the truck's brakes. A folding liner such as described above can solve this problem by folding into a configuration that creates an adjustable compartment in the truck bed. FIG. 3A shows a configuration of a folding liner 100 in which middle section 120 is tilted up from cab-ward section 110 and tail section 130 is folded down from middle section 120 to form a tent-like structure. Hinges 150 connecting sections 120 and 130 may have a limited range of tilting so that the tent like structure cannot collapse toward the cab of truck 200. For example, hinges 150 on sections 120 and 130 may not be able to allow tail section 130 to tilt more than 90° downward from section 120. The configuration of liner 100 in FIG. 3A leaves a portion of floor 212 of bed 210 nearest tailgate 220 and approximately the size of a car trunk exposed, and allows the loading of smaller cargo 310 (e.g., groceries etc.) in a partition next to tailgate 220. Tail section 130 of liner 100 can then be adjusted (within its range of motion) to change the size of the smaller cargo area and thereby snugly hold the cargo 310 up against tailgate 220 and keep cargo 310 from tipping or sliding.

The use of a 270° hinge for hinges 140 and 150 allows each sections 120 or 130 of liner 100 to fold down over the tailgate at a 90° angle, and tail section 130 of liner 100 to fold up (or down) onto the floor at a 90° angle and also allows for sections 120 and 13 fold up into a tent and lock at a 90°. angle. With sections 120 and 130 sized for a six to eight foot truck bed, e.g., each about 24″ to 30″ long, this creates a raised section about 18″ tall, toward the back of truck bed 210 that keeps smaller load 310 from sliding to the front of truck bed 210 during transport and braking. This tent-shaped front section can also be pulled forward to change the tilt angles of sections 120 and 130 to create an “exact size” compartment immediately behind tailgate 220.

FIG. 3B shows an alternative configuration of a folding liner 100 in which just tail section 130 is tilted up form a wall that partitions bed 210 into a small cargo area near tailgate 220 and a larger cargo area closer to the cab of truck 200. Hinges 150 connecting sections 120 and 130 may have a limited range of tilting so that tail section 130 cannot be tilted up more than 90°. The configuration of liner 100 in FIG. 3B leaves a portion of floor 212 of bed 210 nearest tailgate 220 exposed and allows the loading of smaller cargo 320 (e.g., groceries etc.) in a partition next to tailgate 220. Although the configuration of FIG. 3B confines cargo 320 to a smaller area or partition, the partition that the configuration of FIG. 3B provides may not be adjustable.

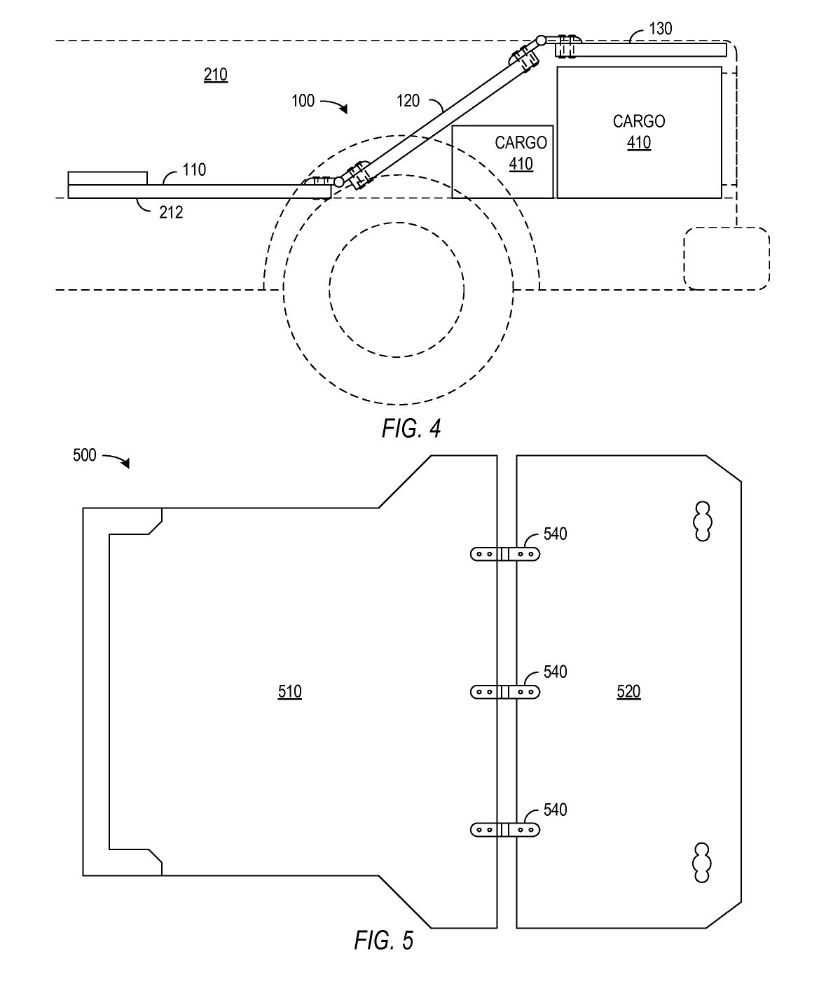

Liner 100 can also fold to cover, secure, and protect a load without the need for cargo nets or having to tie down and tarp a load. FIG. 4 shows a configuration of folding liner 100, cab-ward section 110 is on floor 212 of truck bed 210. Middle section 120 is tilted up from section 110 to provide height for cargo 410, and tail section 130 is tilted down from section 120 to cover cargo 130. Liner 130 may be sufficiently heavy to remain in truck bed 210 during travel or may be tied or loaded down to prevent air movement from lifting liner 130 or cargo 410 out of truck bed 210. Liner 100 in the configuration of FIG. 4 may also or alternatively hide cargo 410 from viewing outside the vehicle.

The example of implementation of liner 100 disclosed above is merely an example, and folding truck liners using the principles disclosed herein may take on many different implementations. For example, although liner 100 has three rigid sections connected with hinge systems, alternative implementations may only have two hinged sections or four or more hinged sections. The implementation of liner 100 shown in FIG. 1A is an example in which sections 110, 120, and 130 are substantially rectangular. Alternatively, one or more section of a folding bed liner may employ sections with different shapes. FIG. 5, for example, shows folding liner 500 including only two sections, a cab-ward section 510 and a tail section 530, connected together with hinges 540. With liner 500, section 530 can be folded or tilted down, e.g., 90°, while section 510 is in position for loading or unloading and be kept flat either when sliding liner 500 further into or out of a cargo area or when section 530 is in position for loading or unloading. Liner 500 may be sized so that length of cab-ward section 510 does not exceed a convenient reach for loading or unloading and so that the length of tail section 530 is less than or at least does not greatly exceed the height of the cargo area above the ground. A two section folding liner may be most suitable for a relatively short cargo area. Liner 500 also illustrates that sections do not need to be rectangular. Section 510 may, for example, be roughly T-shaped and have a portion sized to fit between wheel wells and a portion as wide as the cargo area near a tailgate.

Although particular implementations have been disclosed, these implementations are only examples and should not be taken as limitations. Various adaptations and combinations of features of the implementations disclosed are within the scope of the following claims.

What is claimed is:

1. A folding liner for a cargo area of a vehicle, comprising:
a first section;
a second section;
a third section;
a first hinge system connecting the first section and the second section so that the second section may be tilted relative to the first section; and
a second hinge system connecting the second section and the third section so that the third section may be tilted relative to the second section.

2. The liner of claim 1, wherein each of the first, second, and third sections has a bottom surface that is shaped for sliding on a floor of the cargo area and a top surface that is textured to resist sliding of cargo placed on the top surface.

3. The liner of claim 2, wherein the bottom surface is smooth.

4. The liner of claim 1, wherein one or more of the first, second, and third sections includes a handle.

5. The liner of claim 4, wherein further comprising a lip on an edge of the first section and shaped to prevent cargo from slipping off the liner when a user pulls on the handle.

6. The liner of claim 1, wherein:
the first section has a width sized to slide between wheel wells in the cargo area; and
the second section has a length less than a height of a floor of the cargo area above ground.

7. The liner of claim 6, wherein the third section is wider than the first section and has a width less than a width of the cargo area.

8. The liner of claim 1, wherein the vehicle is a truck and the cargo area is a bed of the truck.

9. The liner of claim 1, wherein the second hinge system limits tilting of the third section in a first direction to no more than 90°.

10. The liner of claim 1, wherein the liner has:
a first configuration in which the first section is on the vehicle and the second section and the third section are outside the vehicle and folded to avoid obstructing loading or unloading of the first section;
a second configuration in which the first section and the second section are on the vehicle, the third section is outside the vehicle and folded to avoid obstructing loading or unloading of the second section; and
a third configuration in which the first section, the second section, and the third sections are flat on a floor of a cargo area of the vehicle.

11. The liner of claim 10, wherein the liner has a fourth configuration in which the third section is folded to create a partition wall between a first portion of the cargo area and a second portion of the cargo area.

12. The liner of claim 10, wherein each of the first, second, and third sections comprises a flat sheet having a bottom surface that is smooth and a top surface that is textured.

13. The liner of claim 12, wherein the third section comprises one or more hand holes extending through the flat sheet of the third section.

14. A process comprising:
placing a folding liner in a first configuration in which a first section of the folding liner in a loading position for a cargo area of a vehicle and second and third sections of the folding liner are folded;
sliding the first section of the folding liner along a floor of the cargo area so that the folding liner moves between the first configuration and a second configuration in which the first section is in the cargo area, the second section is in the loading position, and the third section is folded; and
sliding the first section and the second section of the folding liner along the floor of the cargo area so that the folding liner moves between the second configuration and a third configuration in which the first section and the second section are in the cargo area and the third section is in the loading position.

15. The process of claim 14, further comprising loading first cargo on the first section while the folding liner is in the first configuration, wherein sliding the first section occurs with the first cargo on the first section.

16. The process of claim 15, further comprising loading second cargo on the second section while the folding liner is in the second configuration, wherein sliding the second section occurs with the second cargo on the second section.

17. The process of claim 16, further comprising loading third cargo on the third section while the folding liner is in the third configuration.

18. The process of claim 14, further comprising unloading cargo from the third section while the folding liner is in the third configuration.

19. The process of claim 18, further comprising unloading cargo from the second section while the folding liner is in the second configuration.

20. The process of claim 19, further comprising unloading cargo from the first section while the folding liner is in the first configuration.
